(19) United States
(12) Patent Application Publication
(10) Pub. No.: US 2004/0012326 A1
(43) Pub. Date: Jan. 22, 2004

(54) Vacuum device

(76) Inventors: Cheng-Yi Chang, Hsinchu (TW); Chih-Fang Chen, Miaoli Hsien (TW); Ruey-Feng Jean, Hsinchu Hsien (TW); Shih-Hsien Lin, Hsinchu (TW); Yi-Ming Tsai, Yunlin Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/298,881

(22) Filed: Nov. 18, 2002

(30) Foreign Application Priority Data
Jul. 18, 2002 (TW) 91210954

(51) Int. Cl. H01J 1/62

(52) U.S. Cl. 313/497

(57) ABSTRACT

A vacuum device. The vacuum device includes a frame, a first glass substrate, a second glass substrate and a plurality of metal spacers. The second glass substrate is connected to the first glass substrate by the frame. The plurality of metal spacers are disposed between the first glass substrate and the second glass substrate. The plurality of metal spacers are made of an alloy whose thermal expansion coefficient is between 8×10⁻⁶ and 9×10⁻⁶, and the plurality of metal spacers are bonded to the first glass substrate and the second glass substrate by sealing glass.

### BACKGROUND OF THE INVENTION

1. Field of the Invention

The present invention relates to a vacuum device, and in particular to a vacuum device having a plurality of metal spacers.

2. Description of the Related Art

Referring to FIG. 1, the conventional vacuum device 1 includes two glass substrates 2, 4 and a frame 6. In the manufacturing process, the air between the two glass substrates 2, 4 is pumped out to form a vacuum space. Nevertheless, the two glass substrates 2, 4 cannot withstand the atmospheric pressure. Thus, a plurality of spacers 8 are provided to support the two glass substrates 2, 4.

In the conventional vacuum device 1, the spacer 8 is made of glass to match the glass substrates and enhance light transmission. The spacer 8 is bonded to the glass substrates 2, 4 by sealing glass under a high temperature between 400° C. and 500° C. If the thermal expansion coefficient of the spacer is greatly different from that of the glass substrates, the bonding portions between the spacer and the glass substrates break after bonding. Thus, the thermal expansion coefficient of the spacer 8 must be the same as that of the glass substrates 2, 4 to prevent the bonding portions from breakage.

Nevertheless, since glass is brittle, it is difficult to manufacture the glass spacer. The manufacturing cost of the glass spacer is high and the precision of the glass spacer cannot be easily controlled. Thus, the conventional glass spacer is usually of a simple shape such as a sphere, column or tube as shown in FIG. 3A, FIG. 3B and FIG. 3C, respectively.

Consequently, the invention provides a vacuum device having a plurality of metal spacers. The metal spacer is made of a special alloy and can be easily formed by molding. Specifically, the thermal expansion coefficient of the metal spacer is close to that of the glass substrates.

### SUMMARY OF THE INVENTION

An object of the invention is to provide a vacuum device. The vacuum device comprises a frame; a first glass substrate; a second glass substrate connected to the first glass substrate by the frame; and a plurality of metal spacers disposed between the first glass substrate and the second glass substrate, wherein the plurality of metal spacers are made of an alloy whose thermal expansion coefficient is between 8×10⁻⁶ and 9×10⁻⁶, and the plurality of metal spacers are bonded to the first glass substrate and the second glass substrate by sealing glass.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional vacuum device;

FIG. 2 shows the vacuum device of the invention;

FIG. 3A shows a conventional spherical spacer;

FIG. 3B shows a conventional columnar spacer;

FIG. 3C shows a conventional tubular spacer;

FIG. 4A shows a metal spacer of the invention; and

FIG. 4B shows another metal spacer of the invention.

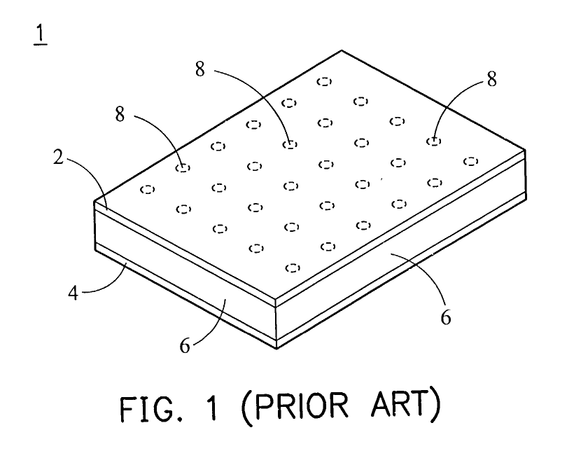

### DETAILED DESCRIPTION OF THE INVENTION

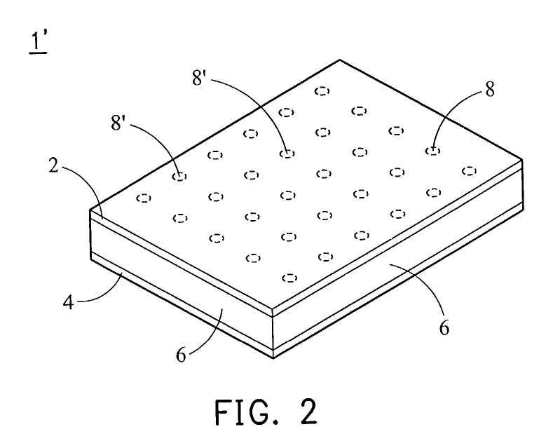

Referring to FIG. 2, the vacuum device 1′ comprises a frame 6, a first glass substrate 2, a second glass substrate 4 and a plurality of metal spacers 8′. The second glass substrate 4 is connected to the first glass substrate 2 by the frame 6. The plurality of metal spacers 8′ are disposed between the first glass substrate 2 and the second glass substrate 4. The metal spacers 8′ are bonded to the first glass substrate 2 and the second glass substrate 4 by sealing glass. The metal spacers 8′ are made of an alloy containing nickel and iron. Specifically, the thermal expansion coefficient of the alloy is between 8×10⁻⁶ and 9×10⁻⁶. The first glass substrate 2 and the second glass substrate 4 are made of sodium glass. The thermal expansion coefficient of the sodium glass is between 8×10⁻⁶ and 9×10⁻⁶ as well. The thermal expansion coefficient of the metal spacers 8′ is close to that of the first glass substrate 2 and the second glass substrate 4. Thus, the bonding portions between the metal spacer 8′ and the first glass substrate 2 and between the metal spacer 8′ and the second glass substrate 4 are not broken after the metal spacer 8′ is bonded to the first glass substrate 2 and the second glass substrate 4 at a high temperature.

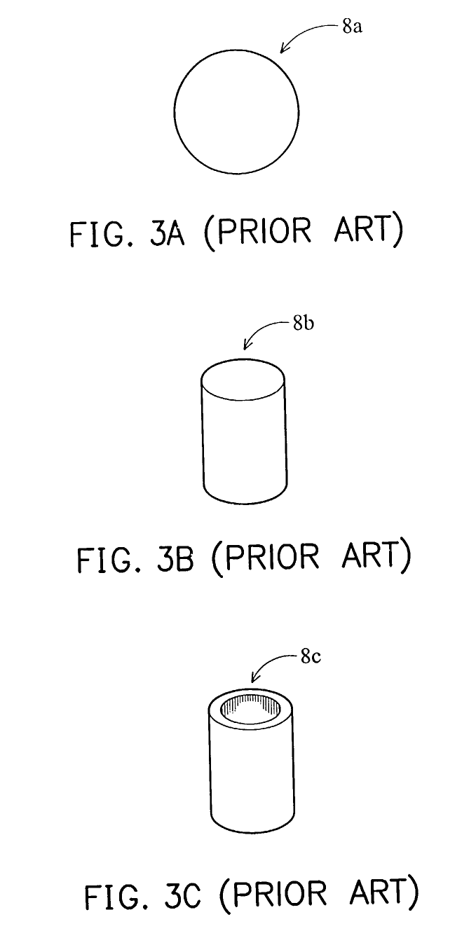

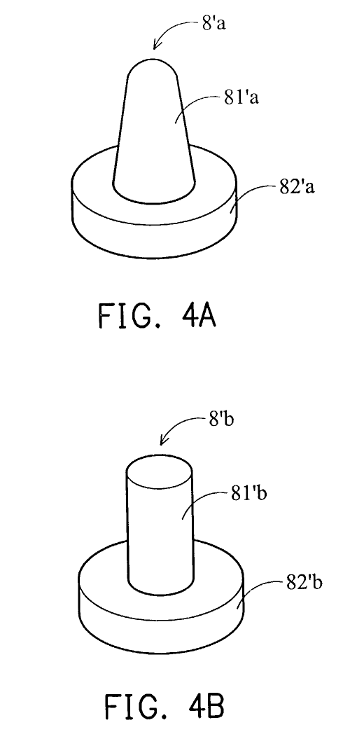

In addition to the configurations of the conventional spacers 8a, 8b and 8c as shown in FIG. 3A, FIG. 3B and FIG. 3C, respectively, the metal spacer 8′ can be cast by particular molds to have the configurations shown in FIG. 4A and FIG. 4B.

As shown in FIG. 4A, the metal spacer 8′a is composed of a cone 81′a and a circular base 82′a. As shown in FIG. 4B, the metal spacer 8′b is composed of a column 81′b and a circular base 82′b.

In another aspect, since the light transmission in the vacuum device 1′ having the metal spacers 8′ deteriorates slightly, a diffuser (not shown) can be disposed on the vacuum device 1′ to improve the light transmission thereof.

To conclude, the metal spacer 8′ of the invention has the following advantages:

(1) It is made of malleable metal such that it can be easily formed.

(2) It is easily mass produced.

(3) Its manufacturing cost is low.

(4) Its tolerance can be controlled within ±0.01 mm.

(5) It can be cast to various complicated shapes to comply with the design of the vacuum device.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A vacuum device, comprising:
a frame;
a first glass substrate;
a second glass substrate connected to the first glass substrate by the frame; and
a plurality of metal spacers disposed between the first glass substrate and the second glass substrate, wherein the plurality of metal spacers are made of an alloy whose thermal expansion coefficient is between 8×10⁻⁶ and 9×10⁻⁶, and the plurality of metal spacers are bonded to the first glass substrate and the second glass substrate by sealing glass.

2. The vacuum device as claimed in claim 1, wherein the metal spacers are made of an alloy containing nickel and iron.

3. The vacuum device as claimed in claim 1, wherein the first glass substrate and the second glass substrate are made of sodium glass.

4. The vacuum device as claimed in claim 1, wherein the metal spacers are formed by casting.

5. The vacuum device as claimed in claim 1, wherein the vacuum device is a backlight module for a LCD device.

6. The vacuum device as claimed in claim 1, wherein the metal spacers include a cone and a circular base.

7. The vacuum device as claimed in claim 1, wherein the metal spacers include a column and a circular base.
